(19) United States
(12) Patent Application Publication
(10) Pub. No.: US 2018/0079013 A1
(43) Pub. Date: Mar. 22, 2018

(54) INFINITE ANGLE CHAMFERING TOOL

(71) Applicant: Caterpillar Inc., Peoria, IL (US)

(72) Inventors: Tyler Brett Fischer, Peoria, IL (US); Rohit Arun Bhapkar, Dunlap, IL (US); Craig Thomas Woodin, Peoria, IL (US)

(73) Assignee: Caterpillar Inc., Peoria, IL (US)

(21) Appl. No.: 15/269,433

(22) Filed: Sep. 19, 2016

(51) Int. Cl. B23B 51/10

(52) U.S. Cl. CPC B23B 51/103; B23B 2220/04; B23B 2260/088; B23B 2251/04; B23B 2260/004; B23B 2215/72

(57) ABSTRACT

A tool unit for performing a chamfering operation on a workpiece is disclosed. The tool unit includes a body, a plunger, at least one insert holder, and at least one cutter insert. The body includes a bore, and the plunger is movably positioned within the bore. The insert holder is coupled to the body and is in engagement with the plunger. The cutter insert is coupled to the at least one insert holder. The cutter insert includes a cutting edge adapted to be positioned at a cutting angle relative to the workpiece, and the cutting angle is varied relative to the workpiece upon a movement of the plunger within the bore.

### TECHNICAL FIELD

The present disclosure relates to a tool unit for performing chamfering operations on a workpiece. More particularly, the present disclosure relates to a tool unit that includes a cutting edge with a cutting angle that may be infinitely adjusted relative to the workpiece.

### BACKGROUND

Metal cutting processes quite frequently involve chamfering operations that help form characteristic profiles at edges of a workpiece. To chamfer edges of a bore or a shaft, for example, machines involving a rotatable shank may be used, and which may shape an edge of the bore or the shaft at a specified angle. Quite often, such processes also require the edges of perhaps the same or different workpieces to be produced at different chamfer angles. To accomplish such chamfering requirements, a chamfering tool may be replaced with a differently angled chamfering tool. However, it may become rather time consuming and laborious if such replacements are frequently sought, such as observed during high productivity cycles.

U.S. Pat. No. 9,216,458 ('458 reference) relates to a cutting tool for use in metal cutting processes in general, and for chamfering operations in particular. The '458 reference discusses an increase and a decrease of an insert cutting angle of the cutting tool by steps of a release of a fastener associated with the cutting tool, reorienting an insert cartridge of the cutting tool, and retightening the fastener.

### SUMMARY OF THE INVENTION

In one aspect, the disclosure is directed towards a tool unit for performing a chamfering operation on a workpiece. The tool unit includes a body, a plunger, at least one insert holder, and at least one cutter insert. The body includes a bore, and the plunger is movably positioned within the bore. The insert holder is coupled to the body and is in engagement with the plunger. The cutter insert is coupled to the at least one insert holder. The cutter insert includes a cutting edge adapted to be positioned at a cutting angle relative to the workpiece, and the cutting angle is varied relative to the workpiece upon a movement of the plunger within the bore.

In another aspect, the disclosure relates to a tool unit for performing a chamfering operation. The tool unit includes a body with a bore, and a plunger movably positioned within the bore. The tool unit further includes at least one insert holder coupled to the body. The insert holder is in engagement with the plunger, and rotated relative to the body upon a movement of the plunger within the bore. The tool unit includes at least one cutter insert coupled to the insert holder.

In yet another aspect, the disclosure is directed to a method for performing a chamfering operation on a workpiece. The method includes using a tool unit. The tool unit includes a body with a bore, a plunger movable within the bore, and an insert holder coupled to the body and in engagement with the plunger, at least one cutter insert being coupled to the insert holder and including a cutting edge to perform the chamfering operation. The insert holder is shaped substantially as a sector of a circle and defines an arcuate face, a first side face, and a second side face, and at least one of the first side face and the second side face form the cutting edge. The method further includes moving the plunger relative to the bore, and moving the insert holder relative to the body and causing the cutting edge to be angularly varied relative to the workpiece.

### BRIEF DESCRIPTION OF THE DRAWINGS

FIG. 1 is a view of a first state of a tool holder, depicted in conjunction with a workpiece, in accordance with the concepts of the present disclosure; and

FIG. 2 is a view of a second state of a tool holder, depicted in conjunction with the workpiece, in accordance with the concepts of the present disclosure.

### DETAILED DESCRIPTION

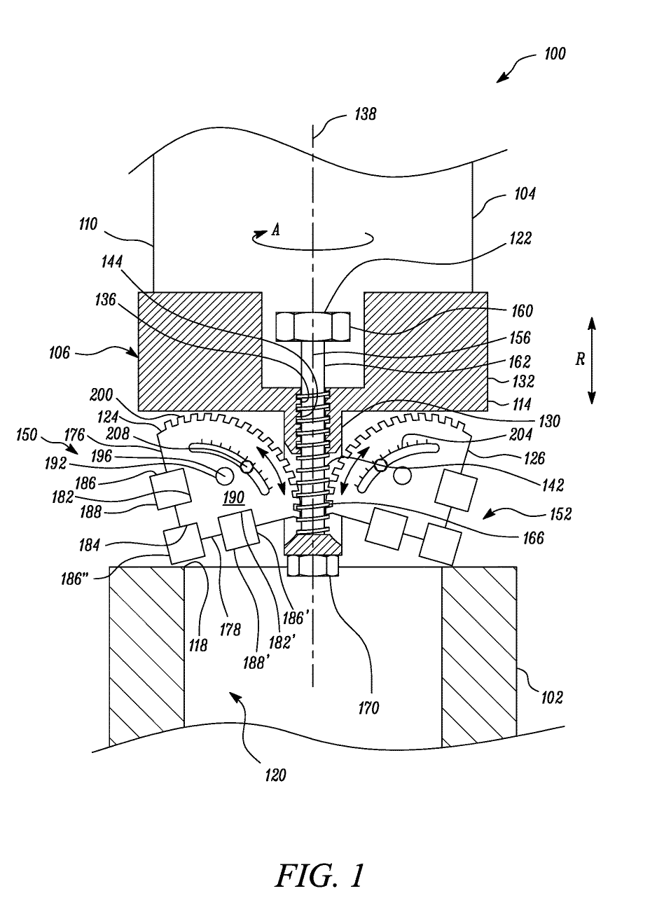

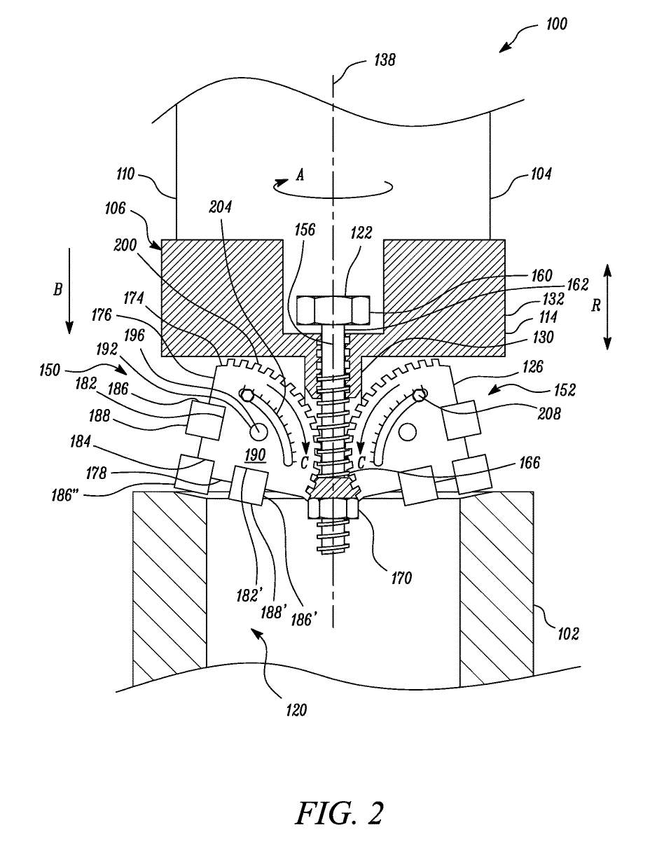

Referring to FIGS. 1 and 2, a cutting tool system 100 is depicted. The cutting tool system 100 is configured to work in conjunction with a workpiece 102, and is adapted for performing a chamfering operation on the workpiece 102. The cutting tool system 100 includes a tool holder 104 and a tool unit 106. Reference will now be made in detail to specific embodiments or features, examples of which are illustrated in the accompanying drawings. Wherever possible, the same reference numbers will be used throughout the drawings to refer to the same or the like parts.

The tool holder 104 may be an end mill with a rotatable shaft portion 110. The rotatable shaft portion 110 may facilitate mounting of the tool unit 106 to the tool holder 104. In this regard, the rotatable shaft portion 110 is in engagement with one or more components (such as a body 114, see FIGS. 1 and 2) of the tool unit 106, as is customary. However, it will be understood that the mounting of the tool unit 106 to the tool holder 104 is not limited to the aspects described in the present disclosure alone, and several methods and measures may be contemplated by which the tool unit 106 may be mounted to the tool holder 104. In some embodiments, the body 114 may use a standard tool adaption surface to be coupled to the tool holder 104. Each such mounting method and measure may be contemplated by someone in the art. The tool holder 104 is adapted to drive (such as by rotation) the tool unit 106 and execute a machining operation, as will be set out and discussed below.

The tool unit 106 may be configured to chamfer an edge 118 of a through-hole 120 of the workpiece 102. However, the tool unit 106 may also be used to chamfer various other corners or other portions of the workpiece 102 during a course of machining. Moreover, the present disclosure is not limited to the use of any specific workpiece, and various other workpieces may use one or more aspects of the present disclosure. The tool unit 106 includes the body 114, a plunger 122, a first insert holder 124, and a second insert holder 126.

The body 114 may include structural features, such as cutouts or walls, etc., that may match with structural features of the rotatable shaft portion 110, so as to be in contact with and be coupled to the rotatable shaft portion 110. The body 114 may include a generally T-shaped structure (or a cross-section), with a stem portion 130 and a head portion 132. The head portion 132 is structured atop the stem portion 130, as is depicted in the orientations disclosed in FIGS. 1 and 2. The stem portion 130 may include a bore 136 formed substantially linearly, and defined along a length of the stem portion 130. The bore 136 may define a bore axis 138. In some implementations, the bore 136 includes protrusions 142 structured about an inner wall 144 of the bore 136, as shown. Given the T-shaped structure of the body 114, the body 114 defines a first quadrant portion 150 and a second quadrant portion 152. Although not limited, the body 114 may be formed of aluminum. In some instances, however, alloys of aluminum may be considered as well.

The plunger 122 may be an elongated member configured to be positioned and assembled into the bore 136. The plunger 122 may be slidably movable (or be reciprocated) within the bore 136, along the bore axis 138. In some implementations, an axis of the plunger (referred to as a plunger axis 156) may be in line with the bore axis 138 when the plunger 122 is assembled within the bore 136. As with conventional fasteners, for example, the plunger 122 may be a screw or a bolt, with a head 160 and a shaft 162. The head 160 may be accessible for movement via an opening structured in the head portion 132 of the body 114, as shown. In some embodiments, the plunger 122 includes an engagement structure 166, such as defined by an inclined plane twisted about an axis. In some embodiments, the engagement structure 166 includes threads, when the plunger 122 is applied as a screw. The engagement structure 166 may be structured over the shaft 162, allowing the plunger 122 to be in engagement with the protrusions 142 formed on the inner wall 144 of the bore 136. In an embodiment, the protrusions 142 formed on the inner wall 144 of the bore 136 are also threads, and which may comply and engage with the threads (engagement structure 166) of the plunger 122. In this regard, the plunger 122 may be rotated (see direction, A) relative to the body 114 and may accomplish a linear movement (such as reciprocation, R) of the plunger 122, along the bore axis 138. Further, the plunger 122 may include a locking device 170, such as a lock nut, to restrain or lock a movement of the plunger 122 relative to the bore 136.

The first insert holder 124 may be an insert cartridge adapted to be positioned and/or be assembled within the quadrant portion 150 of the body 114. Depending upon a machining operation, the first insert holder 124 is adapted to be moved between a first state (FIG. 1) and a second state (FIG. 2). The first insert holder 124 is shaped substantially as a sector of a circle, defining and including an arcuate face 174, a first side face 176, and a second side face 178. The first side face 176 and the second side face 178 are symmetrical and identical to each other, and are defined as radially extending surfaces of a circle that define a profile of the sector-shaped first insert holder 124. The arcuate face 174 is generally directed inwards of the tool unit 106, towards the bore axis 138, in both the first state (FIG. 1) and the second state (FIG. 2). The arcuate face 174 may define an inner periphery of the first insert holder 124. The first side face 176 and the second side face 178 converge towards each other, and are generally directed radially outward of the tool unit 106, in both the first state (FIG. 1) and second state (FIG. 2), as shown.

Each of the first side face 176 and the second side face 178 may include one or more insert pockets 182, 182′, 184 to accommodate one or more cutter inserts 186, 186′, 186″. In the depicted embodiment, each of the first side face 176 and the second side face 178 respectively include the cutter inserts 186, 186′ (i.e. a first cutter insert 186 and a second cutter insert 186′, respectively). Further, a third cutter insert 186″ is arranged at an interface, into insert pocket 184, where the first side face 176 and the second side face 178 meet, thereby forming an edge between the first side face 176 and the second side face 178. The first cutter insert 186 and a portion of the third cutter insert 186″ form a first cutting edge 188 having a first lead angle (or a first cutting angle) of the first insert holder 124, while the second cutter insert 186′ and another portion of the third cutter insert 186″ form a second cutting edge 188′ having a second lead angle (or a second cutting angle) of the first insert holder 124. In some implementations, the first cutting edge 188 and the second cutting edge 188′ may define a combined cutting edge of the first insert holder 124. It is also possible for the only one of the first side face 176 and the second side face 178 to the form a cutting edge of the first insert holder. In some implementations, therefore, it is also possible for only one of the first side face 176 and the second side 178 face to include a single cutter insert 186.

The insert pockets 182, 182′, 184 are adapted to accommodate the cutter inserts. The cutter inserts 186, 186′, 186″ may be removably retained or coupled within the insert pockets 182, 182′ 184. For this purpose, the cutter inserts 186, 186′, 186″ may include fasteners (not shown) to secure the cutter inserts 186, 186′, 186″ within the insert pockets 182, 182′ 184. Further, the first insert holder 124 includes a pair of lateral sides relative to the first side face 176 and the second side face 178. The pair of lateral sides are categorized into a first lateral side 190 and a second lateral side (not shown), the second lateral side being hidden behind the first lateral side 190 in the depicted views of FIGS. 1 and 2. Each of the lateral sides (such as first lateral side 190) are formed in the shape of a slice of a pie, imparting the sector-shaped profile to the first insert holder 124. Further, the first insert holder 124 includes a pin 192 that may slidably pass across the first lateral side 190 and the second lateral side (not shown) of the first insert holder 124, and be connected or coupled to a portion, such as a radially extending wall, of the body 114. In that way, the first insert holder 124 may be configured to pivot or rotatably vary relative to the body 114 about a pivot axis 196 defined by the pin 192. In some implementations, the pivot axis 196 is perpendicular to the plunger axis 156.

The arcuate face 174 includes a mating structure 200 adapted to be engaged to the engagement structure 166, formed on the shaft 162 of the plunger 122. The mating structure 200 may include protrusions, such as teeth, so as to mesh with the engagement structure 166. In an embodiment, the arrangement (or engagement) between the engagement structure 166 of the plunger 122 and the mating structure 200 of the arcuate face 174 is similar to a worm drive arrangement. More particularly, the first insert holder 124 is rotated relative to the body 114 upon a movement (or rotation in direction, A) of the plunger 122 within the bore 136. When viewing FIGS. 1 and 2 together, for example, a motion (see direction, B, FIG. 2) of the plunger 122 obtained by rotation (direction, A) of the plunger 122, may result in the second side face 178 assuming a rotated (direction, C) or a titled position relative to the orientation of the second side face 178 provided in FIG. 1 (second state). Similarly, a counter rotation (opposite to direction, A) of the plunger 122 may return the plunger 122 and the second side face 178 of the first insert holder 124 to the position depicted in FIG. 1 (first state). In an embodiment, the protrusions 142 structured on the inner wall 144 of the bore 136 may be omitted. In such a case, the engagement structure 166 of the plunger 122 may be configured to be in engagement with the mating structure 200 of the arcuate face 174 alone. In some embodiments, the engagement structure 166 of the plunger 122 and the mating structure 200 of the first insert holder 124 is in a rack and pinion type of arrangement with each other. Such an arrangement allows a linear movement (such as a push along direction, B) translating into a direct rotational movement (direction, C) of the first insert holder 124.

Further, the first insert holder 124 includes a discrete ruler setting 204 based on which the first insert holder 124 may be rotated relative to the body 114, and by which a desired discrete position of the first insert holder 124 may be ascertained, if required. Such a setting also determines a chamfering angle (defined by the first cutting edge 188 and/or second cutting edge 188′) relative to a position of the workpiece 102, and according to which the workpiece 102 needs to be machined. The discrete ruler setting 204 includes a retention device 208 or a retention screw to restrict and/or tighten a further variation or movement of the first insert holder 124 relative to the body 114, helping fortify a position of the first insert holder 124 relative to the body 114 and the workpiece 102. To attain an inflexible chamfering angle for operation, the retention provided by the retention device 208 to the first insert holder 124 is in addition to the retention or restrain provided by the locking device 170 to the first insert holder 124, via the plunger 122.

The second insert holder 126 may be adapted to be positioned within the second quadrant portion 152 of the body 114. The second insert holder 126 may be similar in form and function to the first insert holder 124, and the aforementioned description of the first insert holder 124 will be equivalently applicable to the second insert holder 126 as well. It will be appreciated that for ease in understanding and clarity, only details of the first insert holder 124 has been marked. A similar marking scheme, as has been provided for the first insert holder 124, may be envisioned for the second insert holder 126 as well. Although two insert holders (first insert holder 124 and second insert holder 126) have been disclosed, it is possible for the tool unit 106 to include only a single insert holder, or more than two insert holders. Similarly, it is also possible for the first insert holder 124 and/or the second insert holder 126 to include only a single cutter insert (such as cutting insert 186). In some implementations, a movement (rotation) of the second insert holder 126 may be synchronous to a movement of the first insert holder 124, as enabled by the movement (reciprocation) of the plunger 122. It will be understood that a movement of the first insert holder 124 in the direction, C, may translate to a movement of the second insert holder 126 in a direction opposite to the orientation depicted by direction, C.

### INDUSTRIAL APPLICABILITY

During operation, the tool unit 106 is used for changing the cutting angle of the cutter inserts 186, 186′, 186″. In this regard, the plunger 122 is moved relative to the bore 136. By doing so, the first insert holder 124 (and the second insert holder 126) is moved (or rotated) relative to the body 114, which causes the first cutting edge 188 to be angularly varied and positioned at a cutting angle (such as the first cutting angle) relative to the workpiece 102. More particularly, as the plunger 122 is turned in or out or rotated along direction A, (FIG. 1), the engagement structure 166 (or threads) of the plunger 122 engage the mating structure 200 (or teeth) of the first insert holder 124 (and the second insert holder 126), causing the first insert holder 124 to rotate along direction, C, about the pivot axis 196. Synchronously, the second insert holder 126 also moves or rotates opposite to the direction, C. As a result, both the first insert holder 124 and the second insert holder 126 start varying against their respective discrete ruler settings (such as the discrete ruler setting 204). Notably, the tool unit 106 moves away from the first state (FIG. 1) to the second state (FIG. 2), and it may be understood that there may be infinite positions assumed by the tool unit 106 in between said first state and second state, given the worm drive arrangement between the plunger 122 and the first and second insert holders 124 and 126. Once a position of the first insert holder 124 and the second insert holder 126 is determined by use of the discrete ruler setting 204 (and the discrete ruler setting provided for the second insert holder 126), and a desired cutter angle is achieved, the locking device 170 (such as a lock nut) is used to clamp down the plunger 122 against further movement along direction, A. Further, the retention device 208 is used to further tighten the first insert holder 124 (the second insert holder 126 is tightened by another similar retention device), thereby preventing any movement of the first insert holder 124 and the second insert holder 126 during machining. In effect, the cutting angle (such as the first cutting angle) is varied relative to the workpiece 102 upon a movement of the plunger 122 within the bore 136.

In some implementations, multiple insert holders (such as the first insert holder 124) may be used on the tool unit 106. Each such multiple insert holder may adjust synchronously, so that a lead angle (such as the first lead angle or the first cutting angle) of the cutter inserts 186, 186′, 186″ is consistent across each insert holders 124, 126 deployed around the tool unit 106 relative to the body 114 and/or the workpiece 102. In an embodiment, the insert pockets 182, 182′, 184 may be formed so as to accommodate different cutter inserts that may be obtained from various suppliers without replacing the body 114, or any other component of the tool unit 106. In an embodiment, the cutter inserts 186, 186′, 186″ may include multiple inserts, to allow milling in both a face milling style or shoulder milling style, allowing increased depths of cut over a single inserted tool unit 106. Since the same tool unit 106 may be applied for attaining multiple (or infinite) chamfering angles, production and machining of workpieces, such as workpiece 102, during high productivity cycles may take lesser time and effort.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A tool unit for performing a chamfering operation on a workpiece, comprising:
a body with a bore;
a plunger movably positioned within the bore;
at least one insert holder coupled to the body and in engagement with the plunger; and
at least one cutter insert coupled to the at least one insert holder, the at least one cutter insert including a cutting edge, wherein
the cutting edge is adapted to be positioned at a cutting angle relative to the workpiece, and
the cutting angle is varied relative to the workpiece upon a movement of the plunger within the bore.

2. The tool unit of claim 1, wherein the at least one insert holder is shaped substantially as a sector of a circle and defines an arcuate face, a first side face, and a second side face, wherein at least one of the first side face and the second side face forms the cutting edge.

3. The tool unit of claim 2, wherein the arcuate face includes a mating structure.

4. The tool unit of claim 3, wherein the mating structure includes protrusions.

5. The tool unit of claim 3, wherein the plunger includes an engagement structure to mesh with the mating structure.

6. The tool unit of claim 5, wherein the plunger is a screw and the engagement structure includes threads of the screw.

7. The tool unit of claim 1, wherein the at least one insert holder is rotated relative to the body upon a movement of the plunger within the bore.

8. The tool unit of claim 1, wherein the at least one insert holder includes a discrete ruler setting based on which the at least one insert holder is rotated relative to the body.

9. The tool unit of claim 1, further including a locking device to restrain a movement of the plunger relative to the bore.

10. The tool unit of claim 1, wherein the at least one insert holder includes one or more insert pockets adapted to accommodate the at least one cutter insert.

11. A tool unit for performing a chamfering operation, comprising:
a body with a bore;
a plunger movably positioned within the bore;
at least one insert holder coupled to the body and in engagement with the plunger; and
at least one cutter insert coupled to the at least one insert holder, and including a cutting edge, wherein
the at least one insert holder is rotated relative to the body upon a movement of the plunger within the bore.

12. The tool unit of claim 11, wherein the at least one insert holder includes a discrete ruler setting based on which the at least one insert holder is rotated relative to the body.

13. The tool unit of claim 11, wherein the plunger defines a plunger axis for a movement through the bore and the at least one insert holder defines a pivot axis for a rotatable variation relative to the body, the plunger axis being perpendicular to the pivot axis.

14. The tool unit of claim 11, wherein the at least one insert holder is shaped substantially as a sector of a circle and defines an arcuate face, a first side face, and a second side face, wherein at least one of the first side face and the second side face forms the cutting edge.

15. The tool unit of claim 14, wherein the arcuate face includes a mating structure.

16. The tool unit of claim 15, wherein the plunger includes an engagement structure to mesh with the mating structure.

17. The tool unit of claim 16, wherein the plunger is a screw and the engagement structure is formed by threads of the screw.

18. A method for performing a chamfering operation on a workpiece, the method comprising:
using a tool unit having a body with a bore, a plunger being movable within the bore, and at least one insert holder coupled to the body and being in engagement with the plunger, at least one cutter insert being coupled to the at least one insert holder and including a cutting edge to perform the chamfering operation, wherein
the at least one insert holder is shaped substantially as a sector of a circle and defines an arcuate face, a first side face, and a second side face, and
at least one of the first side face and the second side face forming the cutting edge;
moving the plunger relative to the bore; and
moving the at least one insert holder relative to the body and causing the cutting edge to be angularly varied relative to the workpiece.

19. The method of claim 18 further including locking the plunger relative to the body by a lock nut.

20. The method of claim 18 further including restricting a variation of the at least one insert holder relative to the body by a retention device.
